(19) United States
(12) Patent Application Publication
(10) Pub. No.: US 2005/0178707 A1
(43) Pub. Date: Aug. 18, 2005

(54) Fuel filter with heating device

(75) Inventor: Giorgio Girondi, Mantova (IT)

Correspondence Address: BROWDY AND NEIMARK, P.L.L.C.;624 NINTH STREET, NW, SUITE 300, WASHINGTON, DC, 20001-5303, US

(73) Assignee: UFI Filters S.P.A., Mantova (IT)

(21) Appl. No.: 10/503,236

(22) PCT Filed: Mar. 3, 2003
(86) PCT No.: PCT/EP03/02219

(30) Foreign Application Priority Data
Mar. 8, 2002 (IT) RE2002A000021

(51) Int. Cl. B01D 35/18

(52) U.S. Cl. 210/138; 210/149; 210/184; 210/450

(57) ABSTRACT

Fuel filter comprising a cup shaped outer casing provided in its wall with a fuel exit conduit, and closed by an electrically conductive cover connected to earth and provided with an axial fuel feed conduit with which a filter cartridge of toroidal form is associated coaxial to said axial conduit and is sealedly mounted thereon, said cover presenting an axial hole to sealedly receive a glow plug which extends into the interior of the filter cartridge, said plug comprising an outer sheath in contact with the cover and an axial stem insulated from said outer sheath and arranged to be connected to a power cable, between said outer sheath and said stem there being provided an electrical resistance element powered by said cable via temperature control means.

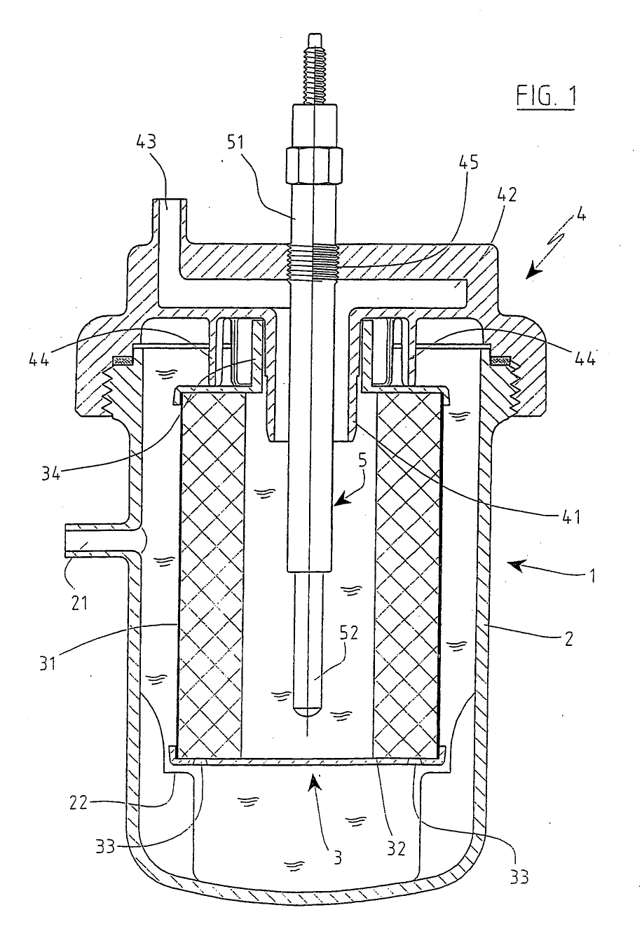

### TECHNICAL FIELD

This invention relates to fuel filters present in diesel engines.

### BACKGROUND ART

The fuel used in such engines contains components, such as paraffin, which tend to thicken to the point of solidifying at low temperature. The presence of a filter is essential to remove the impurities present in the fuel before it is fed to the injection devices, hence if the engine remains inactive for a certain time at a very low temperature of less than −25° C., it becomes impossible to start it because of filter blockage by said components.

The problem of filter blockage due to low temperature arises only on starting, because the diesel oil pumped at high pressure is subjected to sufficient self-heating to prevent separation of components in the solid state, such as the said paraffin.

The problem which has to be overcome is hence limited to that fuel which when the engine is stationary lies within the filter itself and in that conduit between the feed pump and the filter.

Said fuel quantity is generally of the order of 30 cm³ and 1300-1600 cm³ respectively.

To ensure correct engine start, this fuel must be brought to a temperature not less than −10° C.

In the known art, when the temperature is so low as not to enable the engine to be started, it is known to heat the fuel filter from the outside using external means, such as hot water, so enabling the diesel fuel contained therein to be used.

On starting the engine, heating means contained within the filter cover are activated, these generally consisting of a resistance element powered by the vehicle battery.

After a short period of operation, generally between 30 and 50 seconds, said means are deactivated and the engine continues to operate normally. The heating means can be activated only after the engine has started, because the current absorption is such as to rapidly discharge the battery if the engine is not running.

The object of the present patent is to remedy the said drawback by a simple and economical solution.

### DISCLOSURE OF THE INVENTION

Said object is attained by a device having the characteristics defined in the claims.

Essentially, a normal fuel filter comprising a cup-shaped container provided with a conduit which connects it to the outside is closed upperly by a cover provided with an axial conduit associated with a filter cartridge of toroidal form.

The fuel enters the filter through the axial conduit and leaves through the conduit present in the cup.

According to the invention the cover is constructed of a material which is a conductor of electricity, is connected electrically to earth and comprises an axial through seat in which there is sealedly located a glow plug which is prolonged axially into the interior of the central compartment of the cartridge.

Said glow plug has an outer sheath of conductive material, an axial stem which is prolonged to the outside and insulated from the outer sheath, and an electrical resistance element which electrically connects the outer sheath to the axial stem.

That end of said axial stem which is intended to remain external to the filter presents means for its connection to a direct current supply cable. The resistance element has such a value as to almost instantaneously raise the stem temperature to about 40-50° C., current control means being provided such as to ensure that said temperature is maintained for a short period, of some tens of seconds.

Heating the fuel contained in the central compartment of the cartridge enables the engine to be started, with simultaneous deactivation of the glow plug.

The merits and the constructional and operational characteristics of the invention will be apparent from the ensuing detailed description of a preferred embodiment thereof, given by way of non-limiting example with reference to the accompanying figure.

The figure shows an axial section through a fuel filter according to the invention.

The filter 1 comprises a usual cup-shaped outer casing 2 provided with an exit conduit 21 for the filtered fuel and with fins 22 for supporting the filter cartridge 3.

The cartridge 3 is of toroidal form and presents an outer wall 31 impermeable to fuel, and a base 32 having a series of circumferential holes 32 in correspondence with the cartridge base.

The casing 2 is closed upperly by a profiled cover sealedly screwed onto the casing 2.

The cover 4 comprises an axial conduit 41 which extends downwards from a compartment 42 provided within the interior of the cover wall. The compartment 42 presents a conduit 43 which opens to the outside and through which the fuel to be filtered is fed.

External to the conduit 41 there are a series of concentric feet 44 arranged to rest against the top of the cartridge 3 to maintain it in position. The cartridge 3 presents an upper axial conduit 34 to be sealedly fitted over the outside of the conduit 41.

At the centre of the cover there is provided a threaded seat 45 into which the outer sheath of a glow plug 5 is sealedly inserted.

Both said cover and said outer sheath 51 of the glow plug are of a material which conducts electricity, the cover being connected to earth.

The glow plug comprises a central stem 52, electrically insulated from the sheath 51, and extending to the outside of the cover to receive an electrical supply cable.

An electrical resistance element of known value R is connected between the sheath 51 and the stem 52.

With a 12 V d.c. supply, a value of R from 0.5 to 3.5 ohm has proved suitable.

The supply cable is connected to a control circuit governed by a temperature sensor positioned inside the filter cover, and set to maintain the glow plug temperature below 40-50° C.

When the engine is to be started after a prolonged stoppage at a temperature of the order of −40° C., the driver activates the glow plug 5, which develops a quantity of heat sufficient to raise, within a very short time of the order of a few seconds, the temperature of the fuel in the central compartment of the cartridge to a temperature of the order of +10° C.

This enables the engine to start and to operate while the fuel contained in the conduit between the pump and the filter is dispersed, this mixing with the fuel contained in the filter and lowering its temperature to a level not less than −10° C., even with the glow plug deactivated, this being sufficient to prevent separation of the paraffin component.

In a simplified version of the invention, the glow plug is activated via a timer which automatically deactivates it before it reaches a temperature exceeding 40-50° C.

1. A fuel filter comprising a cup shaped outer casing provided in its wall with a fuel exit conduit, and closed by an electrically conductive cover connected to earth and provided with an axial fuel feed conduit with which a filter cartridge of toroidal form is associated coaxial to said axial conduit and is sealedly mounted thereon, characterised in that the cover presents an axial hole to sealedly receive a glow plug which extends into the interior of the filter cartridge, said plug comprising an outer sheath in contact with the cover and an axial stem insulated from said outer sheath and arranged to be connected to a power cable, between said outer sheath and said stem there being provided an electrical resistance element powered by said cable via temperature control means.

2. A filter as claimed in claim 1, characterised in that said temperature control means are current control means governed by a temperature sensor associated with the cover.

3. A filter as claimed in claim 1, characterised in that said temperature control means are a timer arranged to determine the time for which the resistance element is powered.
